(19) United States
(12) Patent Application Publication
(10) Pub. No.: US 2020/0029374 A1
(43) Pub. Date: Jan. 23, 2020

(54) MOBILE COMMUNICATION SYSTEM

(71) Applicant: NTT DOCOMO, INC., Tokyo (JP)

(72) Inventors: Takuya Shimojou, Tokyo (JP); Masayoshi Shimizu, Tokyo (JP); Atsushi Minokuchi, Tokyo (JP); Shigeru Iwashina, Tokyo (JP); Srisakul Thakolsri, Munich (DE); Malla Reddy Sama, Munich (DE); Irfan Ali, Istanbul (TR)

(73) Assignee: NTT DOCOMO, INC., Tokyo (JP)

(21) Appl. No.: 16/338,385

(22) PCT Filed: Sep. 21, 2017
(86) PCT No.: PCT/JP2017/034133

§ 371 Date: Mar. 29, 2019

(30) Foreign Application Priority Data
Sep. 30, 2016 (JP) 2016-194209

(51) Int. Cl. H04W 76/12; H04W 24/02; H04W 76/27; H04W 8/08; H04W 36/00

(52) U.S. Cl. CPC H04W 76/12; H04W 24/02; H04W 92/14; H04W 8/08; H04W 36/0016; H04W 76/27

(57) ABSTRACT

A mobile communication system 8 is a mobile communication system comprising a core network comprising a RAN 3 (a radio access network), an SM 2 (a session management function) that manages a session between a UE 4 (a mobile communication terminal) and an MM 1 (a mobility management function) that manages mobility of the UE 4, and the SM 2 comprises a communication path establishment unit 22 that establishes a communication path enabling communication between the SM 2 and a node of the RAN 3 without passing through the MM 1. The communication path establishment unit 22 may establish a communication path when the communication path establishment unit 22 receives the session construction request at the time of attachment of the UE 4 from the MM 1.

### TECHNICAL FIELD

The present invention relates to a mobile communication system comprising a radio access network, and a core network comprising a session management function for managing a session of a mobile communication terminal and a mobility management function for managing the mobility of the mobile communication terminal.

### BACKGROUND ART

Non-Patent Literature 1 below discloses an architecture of a next generation system (NextGen) of a mobile communication system that is being standardized in the Third Generation Partnership Project (3GPP) that is a standardization project for mobile communication systems.

FIG. 1 is a diagram illustrating an example of a NextGen architecture. The architecture illustrated in FIG. 1 includes mobility management (MM), session management (SM), a radio access network (RAN), user equipment (UE), a U-plane gateway (UP-GW), a domain network name (DNN), and a subscriber data management (SDM). Details of each element (node/function) included in the architecture of FIG. 1 are disclosed in Non-Patent Literature 1 and general literature regarding a mobile communication system, and will not be described. However, the MM, the SM, and the RAN will be briefly described below.

The MM is a mobility management function (or a mobility management node) that manages the mobility of a piece of UL that is a mobile communication terminal, and performs a service request process, modification of a bearer, and the like. The MM is also called a common C-plane. The SM is a session management function (or a session management node) for managing a session of the UE, and performs a process regarding position registration (a tracking area update (TAU) request or response process) or a paging process. In the related art, the function of the MM and the function of the SM are realized by one node or the like. However, in a NextGen architecture, the functions are realized separately like the MM and the SM. The SM is also called C-plane. The RAN is a so-called radio access network (or a node included in a radio access network). It should be noted that nodes included in the RAN are collectively referred to as a RAN in some cases.

As illustrated in FIG. 1, the UE, and the RAN, the UE and the MM, the RAN and the MM, the RAN and the UP-GW, the UP-GW and the SM, the UP-GW and the DNN, the MM and the SDM, and the MM and the SM are connected to be able communicate with each other via a network or the like. Further, the UE and the MM communicate using an interface NG 1, the RAN and the MM communicate using an interface NG 2, the RAN and the UP-GW communicate using an interface NG 3, the UP-GW and the SM communicate using an interface NG 4, the UP-GW and the DNN communicate using an interface NG 6, and the MM and the SDM communicate using an interface NG 7. It should be noted that in FIG. 1, although the RAN and the MM have a one-to-one relationship, the RAN and the MM usually have a many-to-one relationship. Further, in FIG. 1, although the MM and the SM have a one-to-one relationship, the MM and the SM usually have a one-to-many relationship. Further, in FIG. 1, although the SM and the UP-GW have a one-to-one relationship, the SM and the UP-GW may have a one-to-many relationship.

### CITATION LIST

### Non-Patent Literature

[Non-Patent Literature ] 3 GPP TR 23.799 V 1,0.0 (2016-09)

### SUMMARY OF INVENTION

### Technical Problem

In the NextGen architecture illustrated in FIG. 1, the MM is a relay point for relaying communication (signal/message exchange) between the RAN and the SM. In other words, the interface NG 2 exchanges signals of both the MM and the SM. Examples of the exchange of signals performed by the SM using the interface NG 2 may include exchange of a non-access stratum (NAS) message related to bearer establishment, and exchange due to establishment of an RAN data plane bearer (DRB: Data Radio Bearer) and an interface NG 3 bearer. Since the VIM serving as a relay point only relays the exchange of signals between the RAN and the SM as described above, for example, a load due to a relay process of the MM increases. Thus, the NextGen architecture has a problem of redundancy in a network configuration.

Therefore, the present invention has been made in view of the above problem, and an object of the present invention is to provide a mobile communication system capable of reducing redundancy of a network configuration.

### Solution to Problem

In order to solve the problem, a mobile communication system according to an aspect of the present invention is an mobile communication system comprising a radio access network, and a core network comprising a session management function for managing a session of a mobile communication terminal and a mobility management function for managing mobility of the mobile communication terminal, wherein the session management function comprises a communication path establishment unit that establishes a communication path enabling communication between the session management function and a node of the radio access network without passing through the mobility management function.

According to such a mobile communication system, since the communication path establishment unit of the session management function establishes the communication path enabling communication between the session management function and the node of the radio access network without passing through the mobility management function, the session management function and the node of the radio access network can communicate without passing through the mobility management function. Thus, for example, it is not necessary for the mobility management function to relay signal exchange between the session management function and the node of the radio access network. Therefore, a load due to a relay process does not occur. That is, it is possible to reduce redundancy of a network configuration.

### Advantageous Effects of Invention

According to the present invention, it is possible to reduce redundancy of the network configuration.

### BRIEF DESCRIPTION OF DRAWINGS

FIG. 1 is a diagram illustrating an example of a NextGen architecture.

FIG. 2 is a system configuration diagram of a mobile communication system according to the embodiment.

FIG. 3 is a functional block diagram of a mobility management function according to the embodiment.

FIG. 4 is a hardware configuration diagram of the mobility management function according to the embodiment.

FIG. 5 is a functional block diagram of a session management function according to the embodiment.

FIG. 6 is a hardware configuration diagram of the session management function according to the embodiment.

FIG. 7 is a functional block diagram of a node of a radio access network according to the embodiment.

FIG. 8 is a hardware configuration diagram of the node of the radio access network according to the embodiment.

FIG. 9 is a sequence diagram illustrating a process at the time of attachment that is executed in the mobile communication system according to the embodiment.

FIG. 10 is a sequence diagram illustrating a process (part 1) at the time of handover that is executed in the mobile communication system according to the embodiment.

FIG. 11 is a sequence diagram illustrating a process (part 2) at the time of handover that is executed in the mobile communication system according to the embodiment.

### DESCRIPTION OF EMBODIMENTS

Hereinafter, an embodiment of a mobile communication system will be described in detail with reference to the drawings. It should be noted that in the description of the drawings, the same elements are denoted by the same reference numerals, and redundant descriptions will be omitted.

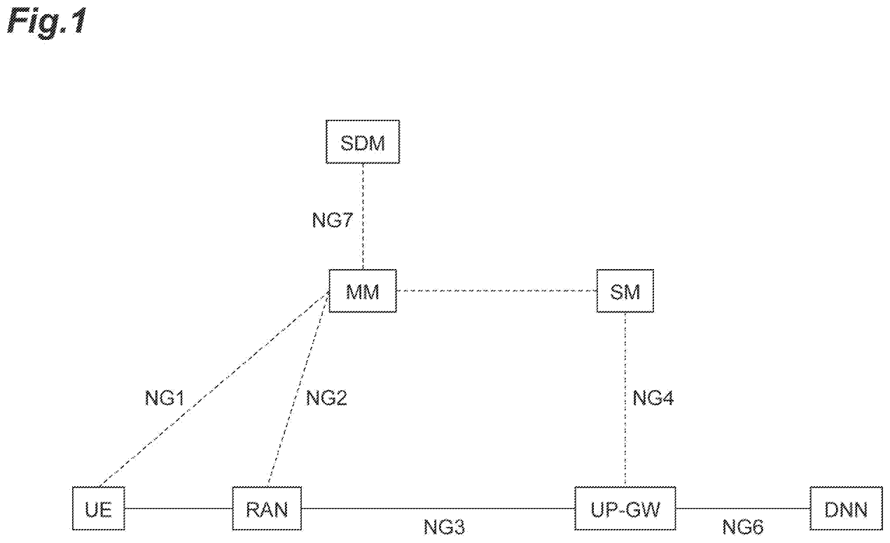

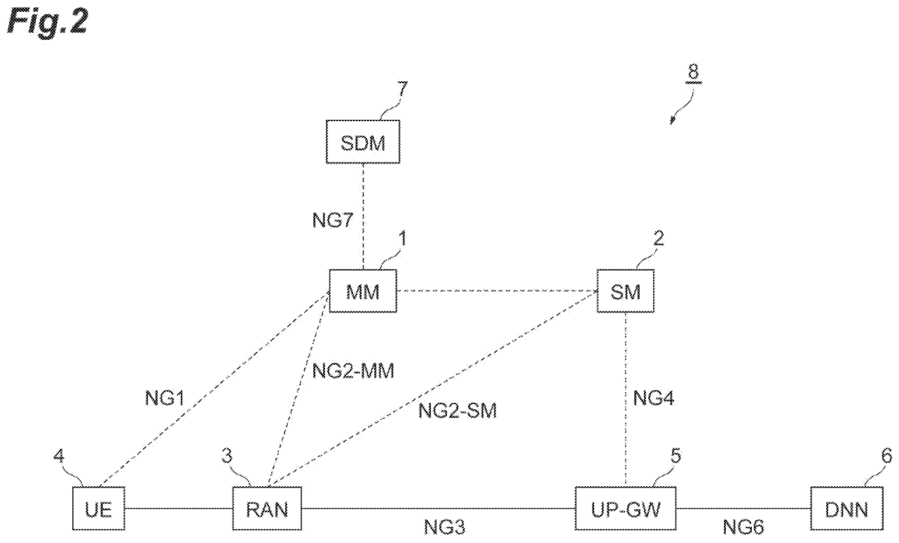

FIG. 2 is a system configuration diagram of a mobile communication system 8 according to the embodiment. As illustrated in FIG. 2, the mobile communication system 8 includes an MM 1 (Mobility Management Function), an SM 2 (Session Management Function), a RAN 3 (Radio Access Network), UE 4 (Mobile Communication Terminal), an UP-GW 5, a DNN 6, and an SDM 7. Each element (node/function) included in the mobile communication system 8 and a connection relationship between the elements are the same as respective elements included in the architecture of FIG. 1 described above and a connection relationship between these elements. That is, the mobile communication system 8 includes the RAN 3, and a core network including the SM 2 that manages a session of the UE 4 and the MM 1 that manages mobility of the UE 4. Differences from the architecture of FIG. 1 will be described below.

In the mobile communication system 8 illustrated in FIG. 2, the interface NG 2 in the architecture illustrated in FIG. 1 is divided into two interfaces including an interface NG 2-MM and an interface NG 2-SM. The MM 1 and the RAN 3 communicate using the interface NG 2-MM, and the SM 2 and the RAN 3 communicate using the interface NG 2-SM. It should be noted that the communication path of the interface NG 2-SM between the SM 2 and the RAN 3 is established by the communication path establishment unit 22 of the SM 2, as will be described below. In the mobile communication system 8, the communication between the MM 1 and the RAN 3 and the communication between the SM 2 and the RAN 3 can be performed directly without interposing other elements through division into the interface NG 2-MM and the interface NG 2-SM. That is, it is not necessary for the MM 1 to relay the communication between the SM 2 and RAN 3.

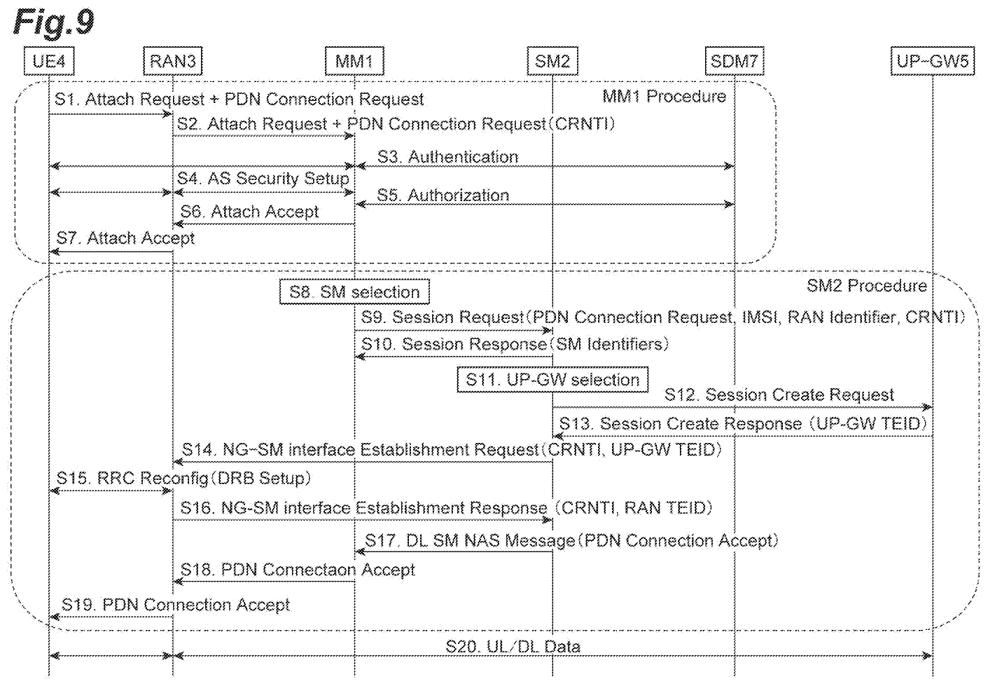

Next, functions of the MM 1, the SM 2 and the RAN 3 will be described below. It should be noted that it is assumed that the MM 1, the SM 2, and the RAN 3 have general functions of respective elements disclosed in Non-Patent Literature 1 “3 GPP TR 23.799 V 1.0.0 (September 2016)”, general literature regarding a mobile communication system, or the like, in addition to functions to be described below. Further, the MM 1, the SM 2, and the RAN 3 also have a function for realizing a process to be described with reference to sequence diagrams of FIGS. 9 to 11 to be described below, in addition to the functions to be described below.

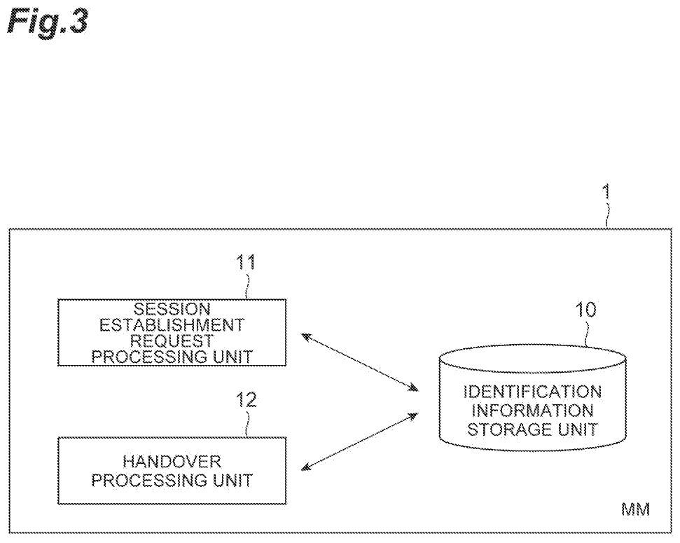

FIG. 3 is a functional block diagram of the MM 1. As illustrated in FIG. 3, the MM 1 includes an identification information storage unit 10, a session construction request processing unit 11, and a handover processing unit 12.

The functional block diagram illustrated in FIG. 3 illustrates blocks in units of functions. These functional blocks (constituent units) are realized by any combination of hardware and/or software. Further, a means for realizing each functional block is not particularly limited. That is, each functional block may be realized by one physically and/or logically coupled device or may be realized by a plurality of devices in which two or more physically and/or logically separated devices may be connected directly and/or indirectly (for example, by a cable and/or wirelessly).

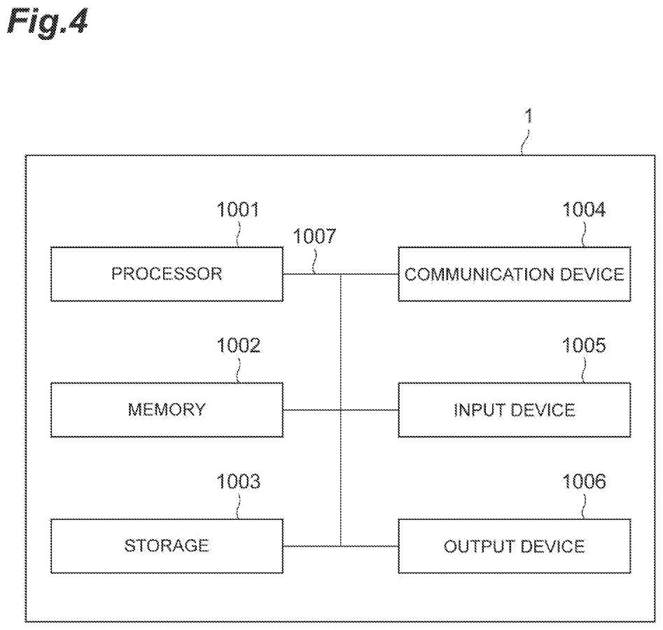

For example, the MM 1 may function as a computer. FIG. 4 is a diagram illustrating an example of a hardware configuration of the MM 1. The MM 1 described above may be physically configured as a computer device including, for example, a processor 1001, a memory 1002, a storage 1003, a communication device 1004, an input device 1005, an output device 1006, and a bus 1007.

It should be noted that in the following description, a term “device” can be referred to as a circuit, device, unit, or the like. The hardware configuration of the MM 1 may be configured to include one or a plurality of devices illustrated in FIG. 4 or may be configured not to include some of the devices.

Each function in the MM 1 is realized by loading predetermined software (program) into hardware such as the processor 1001 or the memory 1002 so that the processor 1001 performs computation to control communication using the communication device 1004 or reading and/or writing data from and/or to the memory 1002 and the storage 1003.

The processor 1001, for example, operates an operating system to control the entire computer. The processor 1001 may be configured as a central processing unit (CPU) including an interface with a peripheral device, a control device, a computation device, a register, and the like. For example, the session construction request processing unit 11 and the handover processing unit 12, and the like described above may be realized by the processor 1001.

Further, the processor 1001 reads a program (program code), a software module, and data from the storage 1003 and/or the communication device 1004 to the memory 1002, and executes various processes according to these. As the program, a program for causing the computer to execute at least a part of the operation described in the embodiment is used. For example, the session construction request processing unit 11, the handover processing unit 12, and the like of the MM 1 may be realized by a control program that is stored in the memory 1002 and operates on the processor 1001, and the other functional blocks are realized in a similar manner. Although the example in which the various processes described above are executed by one processor 1001 has been described, the processes may be executed simultaneously or sequentially by two or more processors 1001. The processor 1001 may be realized using one or more chips. It should be noted that the program may be transmitted from a network via an electrical communication line.

The memory 1002 is a computer-readable recording medium, and may be configured of at least one of a read only memory (ROM), an erasable programmable ROM (EPROM), an electrically erasable programmable ROM (EEPROM), and a random access memory (RAM), for example. The memory 1002 may be referred to as a register, a cache, a main memory (a main storage device), or the like. The memory 1002 can store an executable program (program code), software modules, and the like in order to implement the paging method according to the embodiment.

The storage 1003 is a computer-readable recording medium, and may be configured of, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including the memory 1002 and/or the storage 1003, a server, or other appropriate medium. For example, the identification information storage unit 10 described above may be realized by the storage 1003.

The communication device 1004 is hardware (a transmission and reception device) for performing communication between computers via a wired and/or wireless network, and is also referred to as, for example, a network device, a network controller, a network card, or a communication module. For example, the session construction request processing unit 11 and the handover processing unit 12 described above may be realized by the communication device 1004.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. It should be noted that the input device 1005 and the output device 1006 may be integrated (for example, a touch panel).

Further, the respective devices such as the processor 1001 and the memory 1002 are connected by the bus 1007 for communicating information. The bus 1007 may be configured of a single bus or may be configured of different buses between the devices.

Further, the MM 1 may be configured to include hardware such as a microprocessor, a digital signal processor (DSP), an application specific integrated circuit (ASIC), a programmable logic device (PLD), or a field programmable gate array (FPGA), and part or all of each functional block may be realized by hardware. For example, the processor 1001 may be realized using at least one piece of hardware.

Each functional block of the MM 1 illustrated in FIG. 3 will be described below.

The identification information storage unit 10 stores identification information of each element (for example, the SM 2 or the RAN 3) included in the mobile communication system 8, that is transmitted from each element included in the mobile communication system 8. The identification information storage unit 10 may store the identification information of each element included in the mobile communication system 8 in advance. The identification information storage unit 10 may store other information regarding the mobile communication system 8 in advance.

The session construction request processing unit 11 performs a process of constructing a session of the UE 4 at the time of attachment (Attach) of the UE 4. For example, the session construction request processing unit 11 transmits a construction request for requesting construction of the session of the UE 4 to the SM 2. Here, the SM 2 that is a transmission destination is the SM 2 selected by the MM 1 on the basis of predetermined information. For example, the MM 1 selects an appropriate SM 2 on the basis of one or more of user/service information such as “UE usage type”, “service type”, “dedicated core network (DCN) type”, and “APN”, which are transmitted from the UE 4, the SDM 7, or the like or stored in the identification information storage unit 10 in advance. When the session construction request processing unit 11 transmits the construction request, the session construction request processing unit 11 may include the identification information (radio information) of the RAN 3, that is a communication path establishment target of the SM 2 that is a transmission destination, in the construction request, and transmit the resultant construction request. The identification information of the RAN 3 may be stored in the identification information storage unit 10 in advance or may be transmitted from the RAN 3 at the time of attachment of the UE 4.

The handover processing unit 12 performs a process of performing handover of the UE 4 at the time of handover of the UE 4.

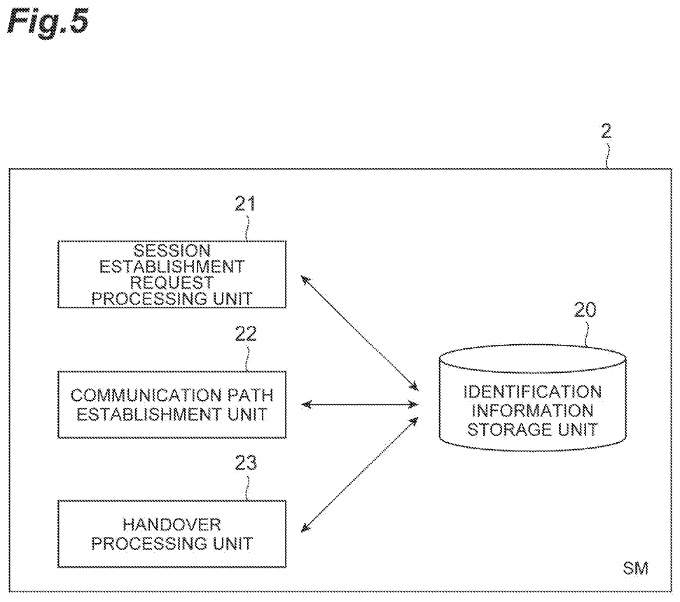

Subsequently, FIG. 5 is a functional block diagram of the SM 2. As illustrated in FIG. 5, the SM 2 includes an identification information storage unit 20, a session construction request processing unit 21, a communication path establishment unit 22, and a handover processing unit 23.

The functional block diagram illustrated in FIG. 5 illustrates blocks in units of functions. These functional blocks (constituent units) are realized by any combination of hardware and/or software. Further, a means for realizing each functional block is not particularly limited. That is, each functional block may be realized by one physically and/or logically coupled device or may be realized by a plurality of devices in which two or more physically and/or logically separated devices may be connected directly and/or indirectly (for example, by a cable and/or wirelessly).

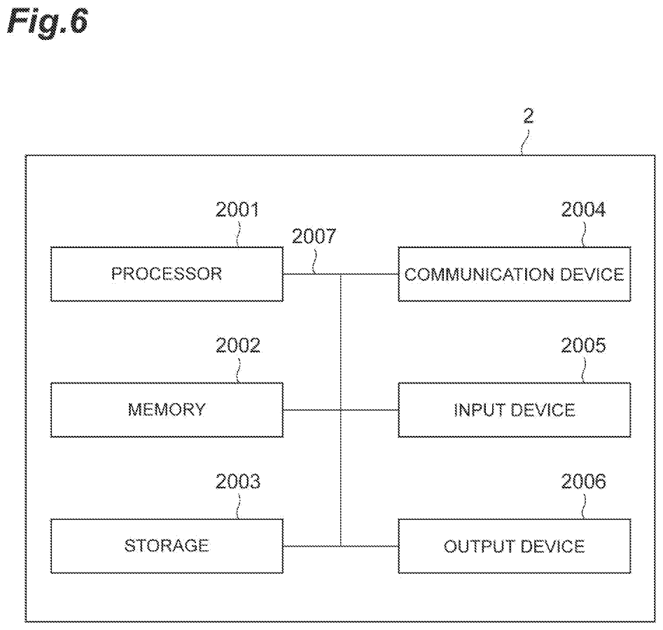

For example, the SM 2 or the like may function as a computer. FIG. 6 is a diagram illustrating an example of a hardware configuration of the SM 2. The SM 2 described above may be physically configured as a computer device including, for example, a processor 2001, a memory 2002, a storage 2003, a communication device 2004, an input device 2005, an output device 2006, and a bus 2007.

The hardware configuration of the SM 2 may be configured to include one or a plurality of devices illustrated in FIG. 6 or may be configured not to include some of the devices.

Each function in the SM 2 is realized by loading predetermined software (program) into hardware such as the processor 2001 or the memory 2002 so that the processor 2001 performs computation to control communication using the communication device 2004 or reading and/or writing data from and/or to the memory 2002 and the storage 2003.

The processor 2001, for example, operates an operating system to control the entire computer. The processor 2001 may be configured as a central processing unit including an interface with a peripheral device, a control device, a computation device, a register, and the like. For example, the session construction request processing unit 21, the communication path establishment unit 22, the handover processing unit 23, and the like described above may be realized by the processor 2001.

Further, the processor 2001 reads a program, a software module, and data from the storage 2003 and/or the communication device 2004 to the memory 2002, and executes various processes according to these. As the program, a program for causing the computer to execute at least a part of the operations described in the embodiment is used. For example, the session construction request processing unit 21, the communication path establishment unit 22, and the handover processing unit 23 of the SM 2 may be realized by a control program that is stored in the memory 2002 and operates on the processor 2001, and the other functional blocks may be realized in a similar manner. Although the example in which the various processes described above are executed by one processor 2001 has been described, the processes may be executed simultaneously or sequentially by two or more processors 2001. The processor 2001 may be realized using one or more chips. It should be noted that the program may be transmitted from a network via an electrical communication line.

The memory 2002 is a computer-readable recording medium, and may be configured of at least one of a ROM, an EPROM, an EEPROM, a RAM, and the like, for example. The memory 2002 may be referred to as a register, a cache, a main memory (a main storage device), or the like. The memory 2002 can store an executable program (program code), software modules, and the like in order to implement the paging method according to the embodiment.

The storage 2003 is a computer-readable recording medium and may be configured of, for example, at least one of an optical disc such as a CD-ROM, a hard disk drive, a flexible disk, a magneto-optical disc, a smart card, a flash memory, a floppy disk, a magnetic strip, and the like. The storage 2003 may be referred to as an auxiliary storage device. The storage medium described above may be, for example, a database including the memory 2002 and/or the storage 2003, a server, or other appropriate medium. For example, the identification information storage unit 20 described above may be realized by the storage 2003.

The communication device 2004 is hardware for performing communication between computers via a wired and/or wireless network, and is also referred to as, for example, a network device, a network controller, a network card, or a communication module. For example, the session construction request processing unit 21, the communication path establishment unit 22, and the handover processing unit 23 described above may be realized by the communication device 2004.

The input device 2005 is an input device that receives an input from the outside. The output device 2006 is an output device that performs output to the outside. It should be noted that the input device 2005 and the output device 2006 may be integrally configured.

Further, each device such as the processor 2001 or the memory 2002 is connected by a bus 2007 for communicating information. The bus 2007 may be configured of a single bus or may be configured of different buses between the devices.

Further, the SM 2 may be configured to include hardware such as a microprocessor, a digital signal processor, an ASIC, a PLD, or a FPGA, and a part or all of each functional block may be realized by hardware. For example, the processor 2001 may be realized using at least one piece of hardware,

Each functional block of the SM 2 illustrated in FIG. 5 will be described below.

The identification information storage unit 20 stores the identification information of each element (for example, the MM 1 or the RAN 3) included in the mobile communication system 8, that is transmitted from each element included in the mobile communication system 8. The identification information storage unit 20 may store the identification information of each element included in the mobile communication system 8 in advance. The identification information storage unit 20 may store other information on the mobile communication system 8 in advance.

The session construction request processing unit 21 performs a process of constructing the session of the UE 4 at the time of attaching the UE 4. For example, the session construction request processing unit 21 receives a construction request for requesting construction of the session of the UE 4 from the SM 2. When the session construction request processing unit 21 receives the construction request, the session construction request processing unit 21 outputs information indicating that the construction request has been received to the communication path establishment unit 22. Further, when the session construction request processing unit 21 receives the construction request, the session construction request processing unit 21 may output the identification information of the node of the RAN 3 included in the construction request to the communication path establishment unit 22. The session construction request processing unit 21 may store the identification information of the node of the RAN 3 included in the construction request in the identification information storage unit 20.

The communication path establishment unit 22 establishes a communication path enabling communication between the SM 2 and the node of the RAN 3 without passing through the MM 1. The establishment of the communication path between the SM 2 and the node of the RAN 3 is to enable communication to be performed between the SM 2 and the node of the RAN 3 using the interface NG 2-SM that is a predetermined interface.

The communication path establishment unit 22 may establish a communication path when the communication path establishment unit 22 receives the session construction request at the time of attachment of the UE 4 from the MM 1. Specifically, when information indicating that the construction request has been received is input from the session construction request processing unit 21, the communication path establishment unit 22 establishes the communication path.

The communication path establishment unit 22 may establish the communication path between the SM 2 and the node of the RAN 3 indicated by the identification information on the basis of the identification information of the node of the RAN 3 included in the construction request. Specifically, when the identification information of the node of the RAN 3 is input from the session construction request processing unit 21, the communication path establishment unit 22 establishes the communication path between the SM 2 and the node of the RAN 3 indicated by the identification information on the basis of the input identification information. It should be noted that the communication path establishment unit 22 may establish the communication path between the SM 2 and the node of the RAN 3 indicated by the identification information on the basis of the identification information of the node of the RAN 3 stored in the identification information storage unit 20.

The handover processing unit 23 performs a process of performing handover of the UE 4 at the time of handover of the UE 4. For example, the handover processing unit 23 may perform communication regarding handover with respect to the node of the RAN 3 indicated by the identification information of the node of the RAN 3 stored in the identification information storage unit 20 in advance or the identification information of the node of the RAN 3 received from the MM 1 without passing through the MM 1.

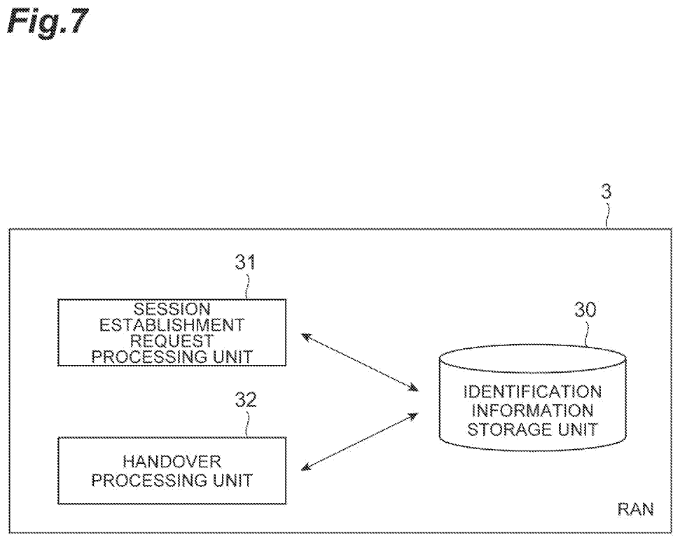

Subsequently, FIG. 7 is a functional block diagram of the RAN 3. As illustrated in FIG. 7, the RAN 3 includes an identification information storage unit 30, a session construction request processing unit 31, and a handover processing unit 32.

The functional block diagram illustrated in FIG. 7 illustrates blocks in units of functions. These functional blocks (constituent units) are realized by any combination of hardware and/or software. Further, a means for realizing each functional block is not particularly limited. That is, each functional block may be realized by one physically and/or logically coupled device or may be realized by a plurality of devices in which two or more physically and/or logically separated devices may be connected directly and/or indirectly (for example, by a cable and/or wirelessly).

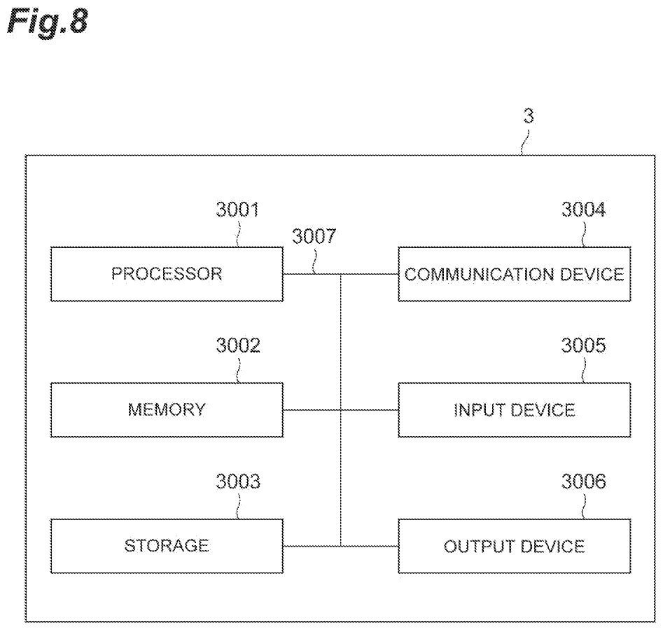

For example, the RAN 3 or the like may function as a computer. FIG. 8 is a diagram illustrating an example of a hardware configuration of the RAN 3. The RAN 3 described above may be physically configured as a computer device including, for example, a processor 3001, a memory 3002, a storage 3003, a communication device 3004, an input device 3005, an output device 3006, and a bus 3007.

The hardware configuration of the RAN 3 may include one or a plurality of devices illustrated in FIG. 8 or may not include some of the devices.

Each function in the RAN 3 is realized by loading predetermined software (a program) into hardware such as the processor 3001, the memory 3002, and the like so that the processor 3001 performs computation to control communication using the communication device 3004 or reading or writing of data from or to the memory 3002 and the storage 3003.

The processor 3001, for example, operates an operating system to control the entire computer. The processor 3001 may be configured as a central processing unit including an interface with a peripheral device, a control device, a computation device, a register, and the like. For example, the session construction request processing unit 31, the handover processing unit 32, and the like described above may be realized by the processor 3001.

Further, the processor 3001 reads a program, a software module, and data from the storage 3003 and/or the communication device 3004 to the memory 3002, and executes various processes according to these. As the program, a program for causing the computer to execute at least a part of the operation described in the embodiment is used. For example, the session construction request processing unit 31 and the handover processing unit 32 of the RAN 3 may be realized by a control program that is stored in the memory 3002 and operates on the processor 3001, and the other functional blocks are realized in a similar manner. Although the example in which the various processes described above are executed by one processor 3001 has been described, the processes may be executed simultaneously or sequentially by two or more processors 3001. The processor 3001 may be realized using one or more chips. It should be noted that the program may be transmitted from a network via an electric communication line.

The memory 3002 is a computer-readable recording medium, and may be configured of at least one of a ROM, an EPROM, an EEPROM, a RAM, and the like, for example. The memory 3002 may be referred to as a register, a cache, a main memory (a main storage device), or the like. The memory 3002 can store an executable program (program code), software modules, and the like in order to implement the paging method according to the embodiment.

The storage 3003 is a computer-readable recording medium and may be configured of, for example, at least one of an optical disc such as a CD-ROM, a hard disk drive, a flexible disk, a magneto-optical disc, a smart card, a flash memory, a floppy disk, a magnetic strip, and the like. The storage 3003 may be referred to as an auxiliary storage device. The storage medium described above may be, for example, a database including the memory 3002 and/or the storage 3003, a server, or other appropriate medium. For example, the identification information storage unit 30 described above may be realized by the storage 3003.

The communication device 3004 is hardware for performing communication between computers via a wired and/or wireless network, and is also referred to as, for example, a network device, a network controller, a network card, or a communication module. For example, the session construction request processing unit 31 and the handover processing unit 32 described above may be realized by the communication device 3004.

The input device 3005 is an input device that receives an input from the outside. The output device 3006 is an output device that performs output to the outside. It should be noted that the input device 3005 and the output device 3006 may be integrally configured.

Further, each device such as the processor 3001 or the memory 3002 is connected by the bus 3007 for communicating information. The bus 3007 may be configured of a single bus or may be configured. of different buses between the devices.

Further, the RAN 3 may be configured to include hardware such as a microprocessor, a digital signal processor, an ASIC, a PLD, or a FPGA, and a part or all of each functional block may be realized by the hardware. For example, the processor 2001 may be realized using at least one of these pieces of hardware.

Hereinafter, each functional block of the RAN 3 illustrated in FIG. 7 will be described.

The identification information storage unit 30 stores identification information of each element (for example, the MM 1 or the SM 2) included in the mobile communication system 8, that is transmitted from each element included in the mobile communication system 8. The identification information storage unit 30 may store identification information of each element included in the mobile communication system 8 in advance. The identification information storage unit 30 may store other information on the mobile communication system 8 in advance.

The session construction request processing unit 31 performs a process of constructing a session of the UE 4 at the time of attachment of the UE 4. For example, the session construction request processing unit 31 cooperates with the communication path establishment unit 22 of the SM 2 to establish a communication path enabling communication between the SM 2 and the node of the RAN 3 without passing through the MM 1.

The handover processing unit 32 performs a process of performing handover of the UE 4 at the time of handover of the UE 4. For example, the handover processing unit 23 may perform communication regarding handover with respect to the SM 2 indicated by the identification information of the SM 2 stored in the identification information storage unit 30 in advance or the identification information of the SM 2 received from the other RAN 3 without passing through the MM 1.

Next, a process at the time of attachment of the UE 4 in the mobile communication system 8 according to the embodiment will be described with reference to a sequence diagram illustrated in FIG. 9.

First, an attachment request and a packet data network (PDN) connection request are transmitted from the UE 4 to the RAN 3 (S1). Then, the attachment request and the PDN connection request are transmitted from the RAN 3 to the MM 1 (S2). It should be noted that the PDN connection request includes cell radio network temporary identity (CRNTI; identification information of the UE 4 as viewed from the RAN 3). Then, an authentication process is executed between the UE 4 and the MM 1 and between the MM 1 and the SDM 7 (S3). Then, AS Security setup is performed between the UE 4 and the RAN and between the RAN 3 and the MM 1 (S4). Then, an authorization process is executed between the MM 1 and the SDM 7 (S5). Then, an attachment acceptance is transmitted from the MM 1 to the RAN 3 (S6). Then, the attachment acceptance is transmitted from the RAN 3 to the UE 4 (S7). Steps S1 to S7 above are processes related to the MM 1.

Following S7, an SM 2 selection process is performed in the MM 1 (S8). As described above, the MM 1 selects the SM 2 on the basis of redetermined information. Hereinafter, the SM 2 is the SM 2 selected in S8. Then, a session request is transmitted from the MM 1 to the SM 2 by the session construction request processing unit 11 of the MM 1 (S9). The session request includes a PDN connection request, international mobile subscriber identity (IMSI), identification information of the RAN 3 (RAN Identifier) described above, and CRNTI. As described above, the identification information of the RAN 3 may be stored in the identification information storage unit 10 in advance or may be transmitted from the RAN 3 at the time of attachment of the UE 4.

Then, a session response is transmitted from the SM 2 to the MM 1 (S10). The session response includes the identification information (SM Identifiers) of the SM 2. Then, a selection process of the UP-GW 5 is performed in the SM 2 (S11). The SM 2 selects the UP-GW 5 on the basis of predetermined information, similar to the selection of the SM 2 in the MM 1 described above. Hereinafter, the UP-GW 5 is the UP-GW 5 selected in S11. Then, a session construction request is transmitted from the SM 2 to the UP-GW 5 (S12). Then, a session construction response is transmitted from the UP-GW 5 to the SM 2 (S13).

Then, the communication path establishment unit 22 of the SM 2 transmits an interface NG 2-SM establishment request from the SM 2 to the RAN 3 (S14). The interface NG 2-SM establishment request includes the CRNTI and a tunnel endpoint identifier (TEID) of the UP-GW 5. Then, radio resource control (RRC) resetting is performed between the UE 4 and the RAN 3 (S15). In the RRC reconfiguration, DRB setting is also performed. Then, the interface NG 2-SM establishment response is transmitted from the RAN 3 to the SM 2 (S16). The interface NG 2-SM establishment response includes CRNTI and RAN TEID. Then, a DL SM NAS message is transmitted from the SM 2 to the MM 1 (S17). The message includes information indicating that the PDN connection has been accepted. Then, PDN connection acceptance is transmitted from the MM 1 to the RAN 3 (S18). Then, a PDN connection acceptance is transmitted from the RAN 3 to the UE 4 (S19). Then, upload/download data is transmitted and received between the UE 4 and the RAN 3 and between the RAN 3 and the UP-GW 5 (S20). Steps S8 to S20 above are a process related to the SM 2.

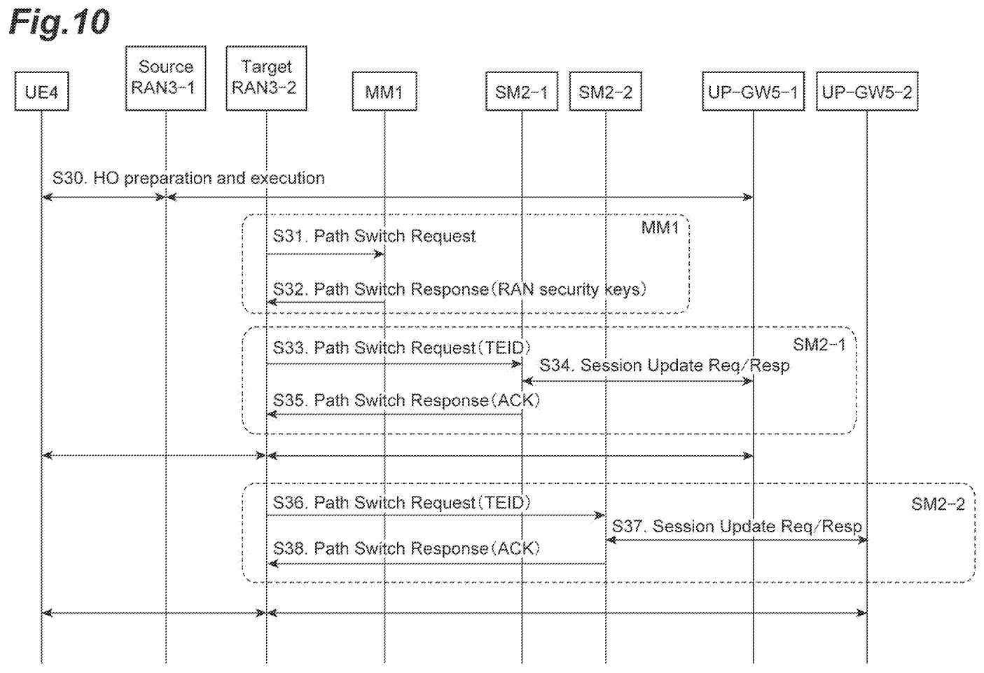

Next, a process (part 1) at the time of handover (X2 handover) of the UE 4 in the mobile communication system 8 according to the embodiment will be described with reference to a sequence diagram illustrated in FIG. 10. This process is a process when the UE 4 hands over from a RAN 3-1 that is a handover source to a RAN 3-2 that is a handover destination. When the UE 4 is present in the RAN 3-1, the UE 4 communicates with an SM 2-1 and an UP-GW 5-1. When the UE 4 is present in the RAN 3-2, the UE 4 communicates with the SM 2-2 and the UP-GW 5-2.

First, a handover preparation and execution process is performed between the UE 4 and the RAN 3-1 and between the RAN 3-1 and the UP-GW 5-1 (S30). Then, a path exchange request is transmitted from the RAN 3-2 to the MM 1 (S31). Then, a path exchange response is transmitted from the MM 1 to the RAN 3-2 (S32). The path exchange response includes a security key of the RAN 3. Steps S31 to S32 above are processes related to the MM 1.

Then, the handover processing unit 32 of the RAN 3-2 transmits the path exchange request from the RAN 3-2 to the SM 2-1 without passing through the MM 1 ( S33). In the S33, the identification information of the SM 2-1 as the transmission destination may be transmitted from the RAN 3-1 to the RAN 3-2 in S30. The path exchange request includes a TEID. Then, a session update request/response is exchanged between the SM 2-1 and the UP-GW 5-1 (S34). Then, the path exchange response is transmitted as ACK without passing through the MM 1 from the SM 2-1 to the RAN 3-2 (S35). S33 to S35 above are processes related to the SM 2-1. Through the above process, communication can be performed between the UE 4 and the RAN 3-2 and between the RAN 3-2 and the UP-GW 5-1.

Then, the path exchange request is transmitted from the RAN 3-2 to the SM 2-2 (S36). In S36, identification information of the SM 2-2 that is a transmission destination may be transmitted from the MM 1 in S32. The path exchange request includes a TEID. Then, a session update request/response is exchanged between the SM 2-2 and the UP-GW 5-2 (S37). Then, a path exchange response is transmitted as ACK from the SM 2-2 to the RAN 3-2 (S38). Steps S36 to S38 above are processes related to the SM 2-2. Through the above process, communication can be performed between the UE 4 and the RAN 3-2 and between the RAN 3-2 and the UP-GW 5-2.

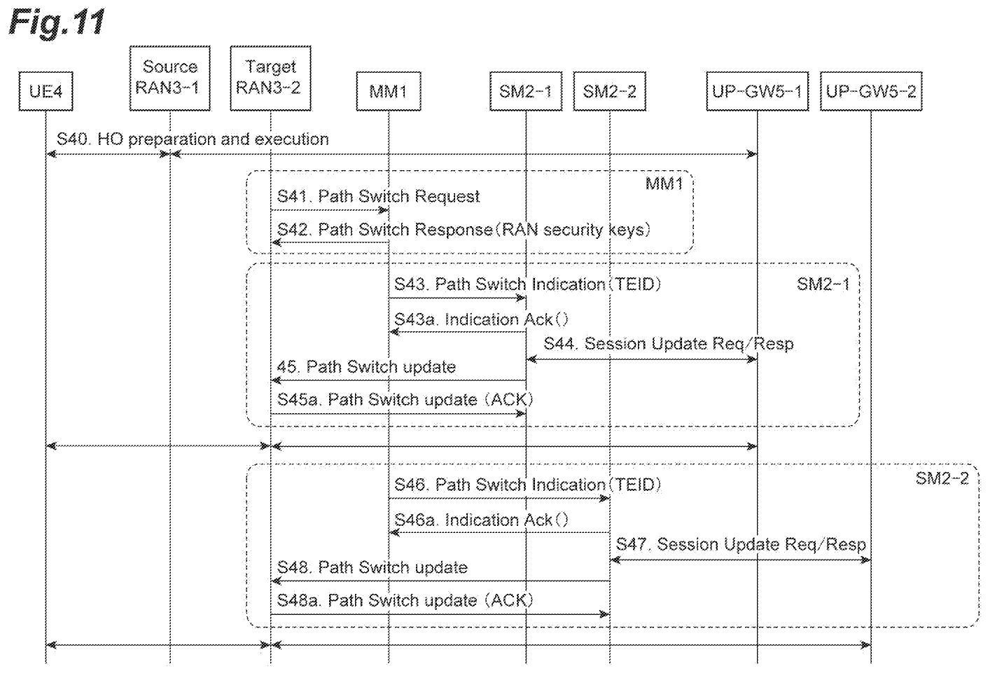

Then, a process (part 2) at the time of handover (X2 handover) of the UE 4 in the mobile communication system 8 according to the embodiment will be described with reference to a sequence diagram illustrated in FIG. 11. This process is a process when the UE 4 hands over from a RAN 3-1 that is a handover source to a RAN 3-2 that is a handover destination, similar to the sequence diagram illustrated in FIG. 10. When the UE 4 is present in the RAN 3-1, the UE 4 communicates with the SM 2-1 and the UP-GW 5-1 When the UE 4 is present in the RAN 3-2, the UE 4 communicates with the SM 2-2 and the UP-GW 5-2.

First, a handover preparation and execution process is performed between the UE 4 and the RAN 3-1 and between the RAN 3-1 and the UP-GW 5-1 (S40). Then, a path exchange request is transmitted from the RAN 3-2 to the MM 1 (S41). Then, a path exchange response is transmitted from the MM 1 to the RAN 3-2 (S42). The path exchange response includes a security key of the RAN 3. Steps S41 to S42 above are processes related to the MM 1.

Then, a path exchange instruction is transmitted from the MM 1 to the SM 2-1 (S43). The path exchange instruction includes the TEID. Then, an instruction ACK is transmitted from the SM 2-1 to the MM 1 (S43a). Then, a session update request/response is exchanged between the SM 2-1 and the UP-GW 5-1 (S44). Then, the handover processing unit 23 of the SM 2-1 transmits a path exchange update request from the SM 2-1 to the RAN 3-2 without passing through the MM 1 (S45). In S45, identification information of the RAN 3-2 that is a transmission destination may be transmitted from the MM 1 in S43. Then, the handover processing unit 32 of the RAN 3-2 transmits an ACK of the path exchange update request from the RAN 3-2 to the SM 2-1 without passing through the MM 1 (S45a). Steps S43 to S45a above are processes related to the SM 2-1. Through the above process, communication can be performed between the UE 4 and the RAN 3-2 and between the RAN 3-2 and the UP-GW 5-1.

Then, the path exchange instruction is transmitted from the MM 1 to SM 2-2 (S46). The path exchange instruction includes the TEED. Then, an instruction ACK is transmitted from the SM 2-2 to the MM (S46a). Then, the session update request/response is exchanged between the SM 2-2 and the UP-GW 5-2 (S47). Then, the handover processing unit 23 of the SM 2-2 transmits the path exchange update request from the SM 2-2 to the RAN 3-2 without passing through the MM 1 (S48). In S48, the identification information of the RAN 3-2 that is a transmission destination may be transmitted from the MM 1 in S46. Then, the handover processing unit 32 of the RAN 3-2 transmits an ACK of the path exchange update request from the RAN 3-2 to the SM 2-2 without passing through the MM 1 (S48a). Steps S46 to S48a above are processes related to the SM 2-2. Through the above process, communication can be performed between the UE 4 and the RAN 3-2 and between the RAN 3-2 and the UP-GW 5-2.

Next, an operation and effects of the mobile communication system 8 configured as in the embodiment will be described.

According to the mobile communication system 8 of the embodiment, since the communication path establishment unit 22 of the SM 2 establishes the communication path enabling communication between the SM 2 and the node of the RAN 3 without passing through the MM 1, the SM 2 and the node of the RAN 3 can communicate without passing through the MM 1. Thus, for example, since there is no need for the MM 1 to relay the exchange of signals between the SM 2 and the node of the RAN 3, a load due to a relay process does not occur. That is, it is possible to reduce redundancy of the network configuration in the mobile communication system 8.

Further, according to the mobile communication system 8 of the embodiment, when the communication path establishment unit 22 receives the session construction request at the time of attachment of the UE 4 from the MM 1, a communication path is established. Thus, it is possible to more reliably establish a communication path not passing through the MM 1. between the SM 2 and the node of the RAN 3 at the time of attachment of the UE 4. Further, in the process at the time of attachment of the UE 4, the MM 1 does not need to relay exchange of signals between the SM 2 and the node of the RAN 3. Thus, a load due to a relay process does not occur. Further, in the process at the time of handover of the UE 4, it is possible to perform exchange of signals between the SM 2 and the nodes of the RAN 3 without passing through the MM 1 using the communication path established at the time of the attachment. Accordingly, since there is no need for the MM 1 to perform relay, a load due to a relay process does not occur, as in the process at the time of the attachment. That is, it is possible to reduce redundancy of the network configuration in the mobile communication system 8.

Further, according to the mobile communication system 8 of the embodiment, the communication path establishment unit 22 establishes the communication path between the SM 2 and the node of the RAN 3 indicated by the identification information on the basis of the identification information of the node of the RAN 3 included in the construction request. Accordingly, it is possible to more reliably establish the communication path between the SM 2 and the designated node of the RAN 3.

Further, according to the mobile communication system 8 of the embodiment, when the handover of the UE 4 is processed, the communication between the SM 2 and the node of the RAN 3 is performed via the communication path established by the communication path establishment unit 22. Accordingly, since it is not necessary for the MM 1 to relay the exchange of signals between the SM 2 and the node of the RAN 3 in the process at the time of the handover of the UE 4, a load due to a relay process does not occur. That is, it is possible to reduce redundancy of the network configuration in the mobile communication system 8.

It should be noted that, in the related art, the interface NG 2 is not divided into two interfaces including the interface NG 2-MM and the interface NG 2-SM, unlike the mobile communication system 8 of the embodiment. For example, in a sequence “4. Bearer Modify Request” shown in a sequence diagram of FIG. 5.4.2.1-1 “Bearer Modification Procedure” in Section 5.4.2.1 and a sequence “4. Bearer Setup Request” shown in a sequence diagram of FIG. 5.4.1-1 “Dedicated Bearer Activation Procedure” in Section 5.4.1 of Non-Patent Literature 1 “3GPP TS 23.401 V14.0.0 (June 2016), exchange is performed in an order of an MM and an SM between eNodeB and MME, and a status of both the MM and the SM is held in the MME. Further, for example, in a NextGen architecture shown in Non-Patent Literature 1 “3GPP TR 23.799 V 1.0.0 (September 2016)”, a daisy chain configuration, UE-(RAN)-MM-SM, is assumed, and the MM relays all messages between the RAN and the SM.

Although the embodiment has been described above in detail, it will be obvious to those skilled in the art that the embodiment is not limited to the embodiments described in the specification. The embodiment can be implemented as variation and modification aspects without departing from the spirit and scope of the present invention as defined by the claims. Therefore, the description of the specification is intended for illustration and does not have any restrictive meaning with respect to the embodiment.

The notification of information is not limited to the aspects/embodiments described in the specification, but may be performed in other ways. For example, the notification of information may be performed by physical layer signaling (for example, downlink control information (DCI) or uplink control information (UCI)), upper layer signaling (for example, radio resource control (RRC) signaling, medium access control (MAC) signaling, reporting information (a master information block (NM)) or a system information block (SIB)), other signals, or a combination thereof. Further, the RRC signaling may be referred to as an RRC message and may be, for example, an RRC connection setup message or an RRC connection reconfiguration message.

Each aspect/embodiment described m the specification can be applied to a system that uses long term evolution (LTE), LTE-Advanced (LTE-A), SUPER 3G, IMT-Advanced, 4G; 5G, Future Radio Access (FRA), W-CDMA (registered trademark), GSM (registered trademark), CDMA 2000, Ultra Mobile Broadband (UMB), IEEE 802.11 (Wi-Fi), IEEE 802.16 (WiMAX), IEEE 802.20, Ultra-Wide Band (UWB), Bluetooth (registered trademark), or another suitable system, and/or a next-generation system expanded based on these.

Further, an order of a processing procedure, sequence, flowchart, and the like of each aspect/embodiment described in the specification may be changed as long as there is no inconsistency. For example, in the method described in the specification, elements of the various steps are presented in an exemplary order and are not limited to the presented specific order.

In the specification, a specific operation that is performed by a specific device may be performed by an upper node in some cases. For example, in a case in which the specific device is a base station, it is obvious that various operations performed for communication with a terminal can be performed by a base station and/or another network node (which may be considered to be an MME or a S-GW, but the present invention is not limited to the MME or the S-GW) other than the base station in a network including one or a plurality of network nodes having the base station. Although the case in which there is one network node other than the base station has been described above, a combination of a plurality of other network nodes (for example, the MME and the S-GW) may be used.

Information or the like can be output from an upper layer (or a lower layer) to the lower layer (or the upper layer). The information or the like may be input or output via a plurality of network nodes.

Input or output information or the like may be stored in a specific place (for example, a memory) or managed in a management table. Information or the like to be input or output can be overwritten, updated, or additionally written. Output information or the like may be deleted. Input information or the like may be transmitted to another device.

Each aspect or embodiment described in the specification may be used singly, may be in combination, or may be switched according to execution and used. Further, a notification of predetermined information (for example, a notification of “being X”) is not limited to being performed explicitly, but may be performed implicitly (for example, not by notifying the predetermined information).

The software is referred to as software, firmware, middleware, microcode, or hardware description language, and can be construed widely to mean instructions, an instruction set, codes, code segments, program codes, a program, a subprogram, a software module, an application, a software application, a software package, a routine, a subroutine, an object, an executable file, an execution thread, a procedure, a function, or the like even though the software is referred to as another name.

In addition, software, instructions, and the like may be transmitted and received via a transmission medium. For example, when the software may be transmitted from a website, a server, or another remote source using wired technology such as a coaxial cable, a fiber optic cable, a twisted pair, or a digital subscriber line (DSL) and/or wireless technology such as infrared rays, wireless technology, or microwaves, these wired and/or wireless technologies are included within a definition of the transmission medium.

The information, signals, or the like described in the specification may be represented using any of a variety of different technologies. For example, data, instruction, command, information, signal, bit, symbol, chip, or the like that can be mentioned throughout the above description may be represented by voltage, current, electromagnetic waves, magnetic field or magnetic particles, or optical field or photons, or in combination.

It should be noted that the terms described in the specification and/or terms necessary for understanding of the specification may be replaced by terms having the same or similar meanings. For example, a channel and/or symbol may be a signal (signal). Further, a signal may be a message. Further, a component carrier (CC) may be referred to as a carrier frequency, a cell, or the like.

The terms “system” and “network” used in the specification are used interchangeably.

Further, the information, parameters, and the like described in the specification may be represented as absolute values, may be represented as relative values from predetermined values, or may be represented by other corresponding information. For example, wireless resource may be indicated by an index.

Names used for the above-described parameters are not limited at any point. Further, mathematical expressions or the like using these parameters may be different from those explicitly disclosed in the specification. Since various channels for example, PUCCH and PDCCH) and information elements (for example, TPC) can be identified by any suitable name, various names assigned to the various channels and information elements are not limited at any point.

A base station can accommodate one or a plurality of (for example, three) cells (also referred to as sectors). In a case in which the base station accommodates a plurality of cells, an entire coverage area of the base station can be divided into a plurality of smaller areas, and each smaller area can provide a communication service using a base station subsystem (for example, a small base station for indoor use, Remote Radio Head (RRH). The term “cell” or “sector” refers to a part or all of a coverage area of a base station and/or base station subsystem that performs a communication service in a coverage of the cell or sector. Further, the terms “base station” “eNB”, “cell”, and “sector” can be used interchangeably herein. The base station may also be referred to as a term such as a fixed station, Node B, eNode B (eNB), an access point, a femtocell, or a small cell.

The mobile communication terminal may be called a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by a person of ordinary skill in the art.

The terms “connected” or “coupled”, or any modification thereof means any direct or indirect connection or coupling between two or more elements, and can include the presence of one or more intermediate elements between two elements “connected” or “coupled” to each other. The coupling or connection between the elements may be physical, may be logical, or may be a combination thereof. In the specification, two elements can be considered to be “connected” or “coupled” to each other by using one or more wires, cables, and/or printed electrical connections, or by using electromagnetic energy such as electromagnetic energy having wavelengths in a radio frequency region, a microwave region, and a light (both visible and invisible) region as some non-limiting and non-comprehensive examples.

Further, a description “on the basis of” used in the specification does not mean “on the basis of only” unless explicitly stated otherwise. In other words, the description “on the basis of” means both “on the basis of only” and “on the basis of at least”.

“Including”, “comprising”, and modifications thereof are intended to be comprehensive like the term “comprising” as long as these are used in the specification or claims. Further, the term “or” used in the specification or claims is intended not to be exclusive disjunction. In the specification, it is assumed that a plurality of devices are also included in cases other than a case in which there is only one device obviously in the context or technically.

Throughout the present disclosure, when articles such as “a”, “an” and “the” in English are added due to translation, it is assumed that the articles include plural ones unless obviously shown otherwise in the context.

### REFERENCE SIGNS LIST

1 MM

2 SM

3 RAN

4 UE

5 UP-GW

6 DNN

7 SDM

8 Mobile communication system

10 Identification information storage unit

11 Session construction request processing unit

12 Handover processing unit

20 Identification information storage unit

21 Session construction request processing unit

22 Communication path establishment unit

23 Handover processing unit

30 Identification information storage unit

31 Session construction request processing unit

32 Handover processing unit

1. A mobile communication system comprising a radio access network, and a core network comprising circuitry for managing a session of a mobile communication terminal and a mobility management function for managing mobility of the mobile communication terminal, wherein
the circuitry establishes a communication path enabling communication between the circuitry and a node of the radio access network without passing through the mobility management function, and
the circuitry establishes the communication path when the circuitry receives a request for construction of the session at the time of attachment of the mobile communication terminal from the mobility management function.

2. (canceled)

3. The mobile communication system according to claim 1, wherein the circuitry establishes, on the basis of identification information of the node of the radio access network comprised in the request for construction, the communication path between the circuitry and the node of the radio access network indicated by the identification information.

4. The mobile communication system according to claim 1, wherein when a handover of the mobile communication terminal is processed, communication between the circuitry and the node of the radio access network is performed via the communication path established by the circuitry.

5. The mobile communication system according to claim 3, wherein when a handover of the mobile communication terminal is processed, communication between the circuitry and the node of the radio access network is performed via the communication path established by the circuitry.
